(19) United States
(12) Patent Application Publication
(10) Pub. No.: US 2025/0324502 A1
(43) Pub. Date: Oct. 16, 2025

(54) LIGHTING CONTROL DEVICE, ILLUMINATION DEVICE, AND VEHICLE LAMP

(71) Applicant: STANLEY ELECTRIC CO., LTD., Tokyo (JP)

(72) Inventors: Takashi FUJINO, Tokyo (JP); Nobuyuki HASHIMOTO, Tokyo (JP)

(73) Assignee: STANLEY ELECTRIC CO., LTD., Tokyo (JP)

(21) Appl. No.: 19/022,921

(22) Filed: Jan. 15, 2025

(30) Foreign Application Priority Data
Jan. 19, 2024 (JP) 2024-006648

(51) Int. Cl. H05B 47/21; B60Q 1/14; H05B 45/345; H05B 45/36; H05B 45/375; H05B 47/155; H05B 47/23

(52) U.S. Cl. CPC H05B 47/21; B60Q 1/1407; H05B 45/345; H05B 45/36; H05B 45/375; H05B 47/155; H05B 47/23

(57) ABSTRACT

A lighting control device controls lighting of a first light source and a second light source having a smaller load than the first light source. The lighting control device includes a voltage supply circuit supplying a driving voltage to the first light source and the second light source, a smooth capacitor absorbing ripples of the driving voltage, a first switching element controlling a current generated by the driving voltage to the first light source, a second switching element controlling a current generated by the driving voltage to the second light source, a control circuit outputting control signals controlling the first switching element and the second switching element, and a bypass circuit forming a bypass path of a current to the second light source. The bypass path is formed by switching the bypass circuit to a conductive state based on a control signal reducing the load among the control signals.

### CROSS-REFERENCE TO RELATED APPLICATIONS

This application claims the benefit of Japanese Patent Application No. 2024-006648, filed Jan. 19, 2024, the entire disclosure of which is incorporated by reference herein.

### FIELD OF THE INVENTION

The present disclosure relates to a lighting control device, an illumination device, and a vehicle lamp.

### BACKGROUND OF THE INVENTION

In a lighting control device for a vehicle lamp, to drive a light emitting string with a configuration in which light emitting elements, such as light emitting diodes (LEDs), are connected in series, a driving voltage is supplied to the light emitting elements by a voltage supply circuit, such as a direct current-to-direct current (DC/DC) converter. Here, a protection circuit is provided in the voltage supply circuit to protect the light emitting elements by preventing a voltage exceeding a rated voltage from being applied to the light emitting elements.

Unexamined Japanese Patent Application Publication No. 2009-006981 discloses a vehicle lamp in which multiple LEDs are connected in parallel to a power supply including an input protection circuit. A Zener diode and a capacitor are connected between a positive wiring and a ground (GND) wiring of the input protection circuit so as to absorb a high voltage at a specified level or higher and a surge voltage that are applied between a positive terminal and a GND terminal, thereby preventing damage to the LEDs.

### SUMMARY OF THE INVENTION

An aspect of a lighting control device according to the present disclosure is a lighting control device to control lighting of a first light source and a second light source, and the second light source has a smaller load than the first light source. The lighting control device includes a voltage supply circuit to supply a driving voltage to each of the first light source and the second light source, a smooth capacitor to absorb ripples of the driving voltage supplied by the voltage supply circuit, a first switching element to control flow of a current generated by the driving voltage to the first light source, a second switching element to control flow of a current generated by the driving voltage to the second light source, a control circuit to output control signals for control of the first switching element and the second switching element, and a bypass circuit to form a bypass path for bypass of a current flowing to the second light source. The bypass path is formed by switching the bypass circuit to a conductive state based on a control signal for reduction of the load among the control signals output by the control circuit.

### BRIEF DESCRIPTION OF DRAWINGS

FIG. 1 is a block diagram illustrating a configuration of a vehicle lamp according to Embodiment 1 of the present disclosure;

FIG. 2A is a waveform diagram illustrating a value of a current that is input to a light emitting element at driving and from which a surge current is removed by a bypass path;

FIG. 2B is a waveform diagram illustrating a current that is input to a light emitting element at driving and is a control signal for control of light emission of the light emitting element;

FIG. 3 is a waveform diagram in which a waveform of a current flowing to the bypass path is added to the waveform diagram of FIG. 2A;

FIG. 4 is a block diagram illustrating a configuration of a vehicle lamp according to Embodiment 2 of the present disclosure;

FIG. 5 is a block diagram illustrating a configuration of a vehicle lamp according to Embodiment 3 of the present disclosure;

FIG. 6A is a block diagram illustrating an example configuration of a vehicle lamp that includes a high-beam light source, a low-beam light source, and a lighting control device for the high-beam light source and the low-beam light source; and

FIG. 6B is a waveform diagram illustrating a value of a current that is input to a light emitting element at driving of the vehicle lamp of FIG. 6A.

### DETAILED DESCRIPTION OF THE INVENTION

Due to advancement of functionality in vehicle lamps, it is necessary to prepare multiple light sources, such as a high-beam light source and a low-beam light source, and to individually control these multiple light sources in accordance with functions thereof to selectively illuminate light. In this case, to implement multiple functions, a lighting control device is provided for each light source. However, if a lighting control device is provided for each of the functions, voltage supply circuits as many as the functions are required. This complicates a configuration and increases a cost. Accordingly, to cause the multiple light souses to emit light in accordance with the functions, a configuration is provided that includes a common lighting control device for the multiple light sources corresponding to the functions and a switching circuit for selective switch of connection between each of the multiple light sources and the voltage supply circuit. This configuration can reduce the number of the voltage supply circuits and avoid a complicated configuration and a cost increase.

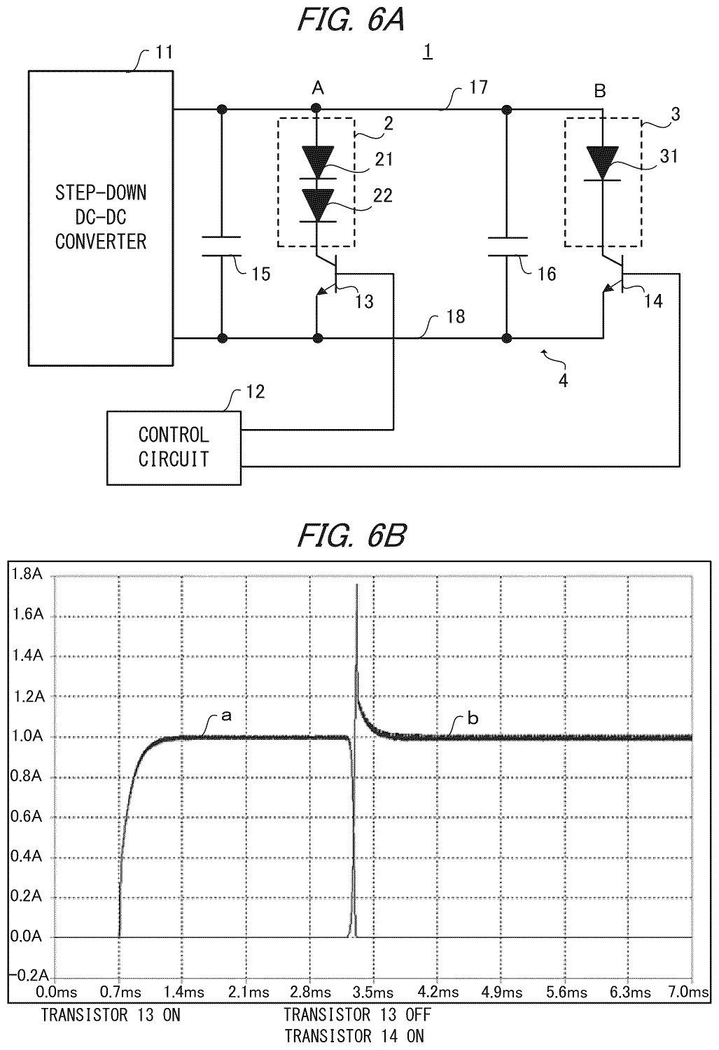

FIG. 6A illustrates, as an example of the above vehicle lamp, a vehicle lamp 1 that includes a high-beam light source 2, a low-beam light source 3, and a lighting control device 4 for control of turn on of the high-beam light source 2 and the low-beam light source 3. The high-beam light source 2 is a light emitting string that includes light emitting elements 21, 22 connected in series, and the low-beam light source 3 includes a light emitting element 31. The low-beam light source 3 has fewer light emitting elements than the high-beam light source 2, and thus has a smaller load than the high-beam light source 2. The lighting control device 4 includes a step-down direct current-to-direct current (DC-DC) converter 11 that is a voltage supply circuit for supply of a driving voltage to each of the high-beam light source 2 and the low-beam light source 3, a control circuit 12 for control of turn on and off of the high-beam light source 2 and the low-beam light source 3, transistors 13, 14 that are switching elements, and capacitors 15, 16 that are smooth capacitors for absorption of ripples generated in the driving voltage supplied from the voltage supply circuit.

The step-down DC-DC converter 11 receives a voltage supply from a non-illustrated power supply to generate a driving voltage, and supplies a driving current to each of the light emitting elements 21, 22, 31 included in the high-beam light source 2 or the low-beam light source 3 by applying the driving voltage thereto.

The control circuit 12 is connected to a control terminal (a base) of each of the transistors 13, 14, and controls a conduction state (conductive/non-conductive) of a current path (between a collector and an emitter) of each of the transistors 13, 14 by supplying control signals to each control terminal.

The control circuit 12 controls the conduction state of each of the transistors 13, 14 so as to selectively turn on the high-beam light source 2 or the low-beam light source 3. When selecting the high-beam light source 2, the control circuit 12 outputs a control signal to the control terminal to switch the transistor 13 to the conductive state. At this time, since the low-beam light source 3 is not selected, the transistor 14 is controlled to switch to the non-conductive state.

When the transistor 13 is switched to the conductive state, a driving voltage is applied by the step-down DC-DC converter 11 to the light emitting elements 21, 22 of the high-beam light source 2, and a driving current is supplied to the light emitting elements 21, 22. At this time, a direct current (DC) voltage is input by the step-down DC-DC converter 11 to the capacitor 15 connected between a positive wiring 17 and a GND wiring 18, and an electric charge is accumulated in the capacitor 15. The capacitor 15 has a capacity to suppress ripples that are voltage fluctuation in response to switching of the transistors 13 and 14 that are switching elements, and to smooth output voltages.

FIG. 6B illustrates a current curve a of a current value at a connection point A that is a connection point between the positive wiring 17 of the step-down DC-DC converter 11 and the high-beam light source 2, and a current curve b of a current value at a connection point B that is a connection point between the positive wiring 17 of the step-down DC-DC converter 11 and the low-beam light source 3.

When the transistor 13 is switched to the conductive state (an ON state), the current value at the connection point A increases rapidly, and a constant driving current that is a rated current value of the light emitting elements 21, 22 is supplied to the light emitting elements 21, 22 to turn on the high-beam light source 2. At this time, the transistor 14 is in the non-conductive state (an OFF state), and the current value at the connection point B is 0.

Next, when changing the function from high beam to low beam, the control circuit 12 turns off the high-beam light source 2 by switching the transistor 13 to the non-conductive state (the OFF state), and turns on the low-beam light source 3 by switching the transistor 14 to the conductive state (the ON state).

In FIG. 6B, switching the transistor 13 to the non-conductive state (the OFF state) causes the current value at the connection point A to decrease rapidly to be 0. In contrast, switching the transistor 14 to the conductive state (the ON state) causes the current value at the connection point B to increase rapidly.

Since the high-beam light source 2 connected to the connection point A includes the light emitting element 21 and the light emitting element 22 connected in series, when the forward voltage of each of the light emitting elements is Vf, the forward voltage of the high-beam light source 2 is 2Vf. In contrast, since the low-beam light source 3 connected to the connection point B includes the light emitting element 31 alone, the forward voltage of the low-beam light source 3 is Vf, that is, the low-beam light source 3 has a smaller load than the high-beam light source 2.

Thus, switching the transistor 13 to the non-conductive state (the OFF state) and switching the transistor 14 to the conductive state (the ON state) reduce the load. Such reduction of the load results in discharge of the electric charge accumulated in the capacitor 15.

Due to discharge from the capacitor 15, in addition to the driving voltage applied from the step-down DC-DC converter 11, a voltage discharged from the capacitor 15 is momentarily applied to the light emitting element 31 of the low-beam light source 3. Thus, a current flowing through the connection point B generates, at rising thereof, a surge current due to discharge from the capacitor 15. Since the surge current has a current value greatly exceeding a rated current value of the light emitting element 31, an excessive current flows to the light emitting element 31. This may damage the light emitting element 31.

Hereinafter, a vehicle lamp according to embodiments of the present disclosure is described with reference to the drawings. In the drawings, the same reference sign is assigned to the same or equivalent parts.

### Embodiment 1

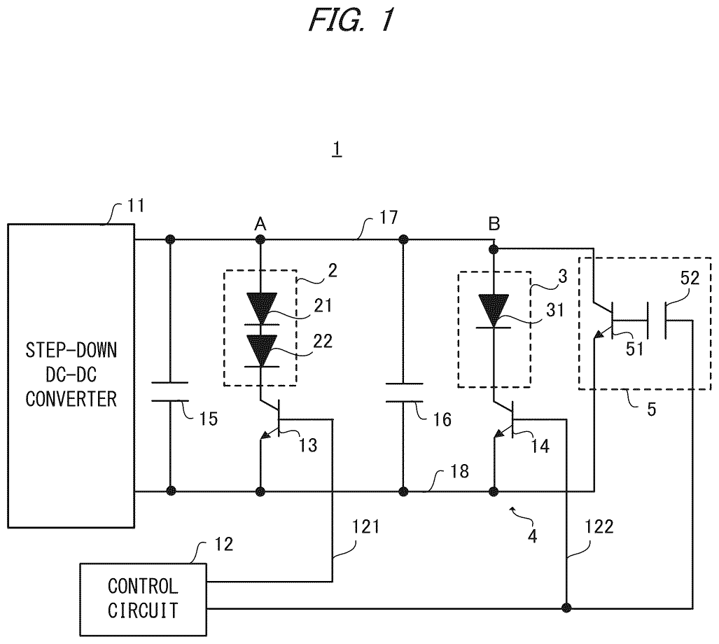

FIG. 1 is a block diagram illustrating a configuration of a vehicle lamp 1. The vehicle lamp 1 includes a high-beam light source 2 (a first light source), a low-beam light source 3 (a second light source), and a lighting control device 4 for control of turn on of the high-beam light source 2 and the low-beam light source 3. The high-beam light source 2 is a light emitting string that includes light emitting elements 21, 22 connected in series, and when the forward voltage of each of the light emitting elements is Vf, the forward voltage of the string is 2Vf. Since the low-beam light source 3 includes a light emitting element 31 alone, the forward voltage of the low-beam light source 3 is Vf. The low-beam light source 3 has fewer light emitting elements than the high-beam light source 2, and thus has a smaller load than the high-beam light source 2. The number of the light emitting elements included in each of the light sources is not limited thereto. The string may include three or more light emitting elements in the high-beam light source 2, and may include two or more light emitting elements in the low-beam light source 3. If the loads of the light sources differ from each other, the number of the light emitting elements included in each of the light sources may be set as appropriate. Although the light emitting elements are identical to one another and the forward voltages thereof are identical to one another in the present embodiment, combination of light emitting elements having, for example, different emitted-light colors may be employed. In this case, the light emitting elements have different forward voltages, and even if the light emitting elements have the same number of lights, the forward voltages thereof differ from one another and the loads thereof differ from one another.

The lighting control device 4 includes a step-down DC-DC converter 11 that is a voltage supply circuit for supply of a driving voltage to each of the high-beam light source 2 and the low-beam light source 3, a control circuit 12 for control of turn on and off of the high-beam light source 2 and the low-beam light source 3, transistors 13, 14 that are switching elements, and capacitors 15, 16 that are smooth capacitors for absorption of ripples generated in the driving voltage supplied by the voltage supply circuit.

The step-down DC-DC converter 11 receives a voltage supply from a non-illustrated power supply to generate a driving voltage, and supplies a driving current to each of the light emitting elements 21, 22, 31 included in the high-beam light source 2 or the low-beam light source 3 by applying the driving voltage thereto. The voltage supply circuit is not limited to a step-down type, and may be a step-up type.

The control circuit 12 is connected to a control terminal (a base) of each of the transistor 13 (a first switching element) and the transistor 14 (a second switching element), and controls a conduction state (conductive/non-conductive) of a current path (between a collector and an emitter) of each of the transistors 13, 14 by supplying control signals to each control terminal. The control circuit 12 controls the conduction state of each of the transistors 13, 14 so as to selectively turn on the high-beam light source 2 or the low-beam light source 3. When selecting the high-beam light source 2, the control circuit 12 outputs a control signal to the control terminal to switch the transistor 13 to the conductive state. At this time, since the low-beam light source 3 is not selected, the transistor 14 is controlled to switch to the non-conductive state. The transistors 13, 14 may be field effect transistors.

When the transistor 13 is switched to the conductive state, a driving voltage is applied by the step-down DC-DC converter 11 to the light emitting elements 21, 22 of the high-beam light source 2, and a driving current is supplied to the light emitting elements 21, 22. At this time, a DC voltage is input by the step-down DC-DC converter 11 to the capacitor 15, and an electric charge is accumulated in the capacitor 15. The capacitor 15 has a capacity to suppress ripples that are voltage fluctuation in response to switching of the transistors 13 and 14 that are switching elements, and to smooth output voltages.

In FIG. 1 that illustrates the vehicle lamp of the present embodiment, the difference from FIG. 6 is that a bypass circuit 5 is provided. The bypass circuit 5 is connected between a positive wiring 17 and a GND wiring 18 in parallel to the low-beam light source 3 (the second light source) and the transistor 14 (the second switching element) for turn on/off of the low-beam light source 3. When switching the function from the high beam to the low beam, that is, at a moment at which a lighting state is switched from the high-beam light source 2 to the low-beam light source 3 and the load decreases, the bypass circuit 5 forms a bypass path for bypass of a current flowing to the low-beam light source 3. A surge current generated by discharge from the capacitor 15 that is a smooth capacitor flows to the bypass path formed by the bypass circuit 5. Specifically, the bypass circuit 5 includes a transistor 51 (a third switching element) and a capacitor 52. A collector of the transistor 51 is connected to the positive wiring 17, and an emitter of the transistor 51 is connected to the GND wiring 18. A base of the transistor 51, that is, a control terminal of the transistor 51 is connected to the capacitor 52. The other end of the capacitor 52 is connected to the control circuit 12, and a control signal for control of the conduction state of the transistor 14 is input by the control circuit 12 to the control terminal of the transistor 51 via the capacitor 52.

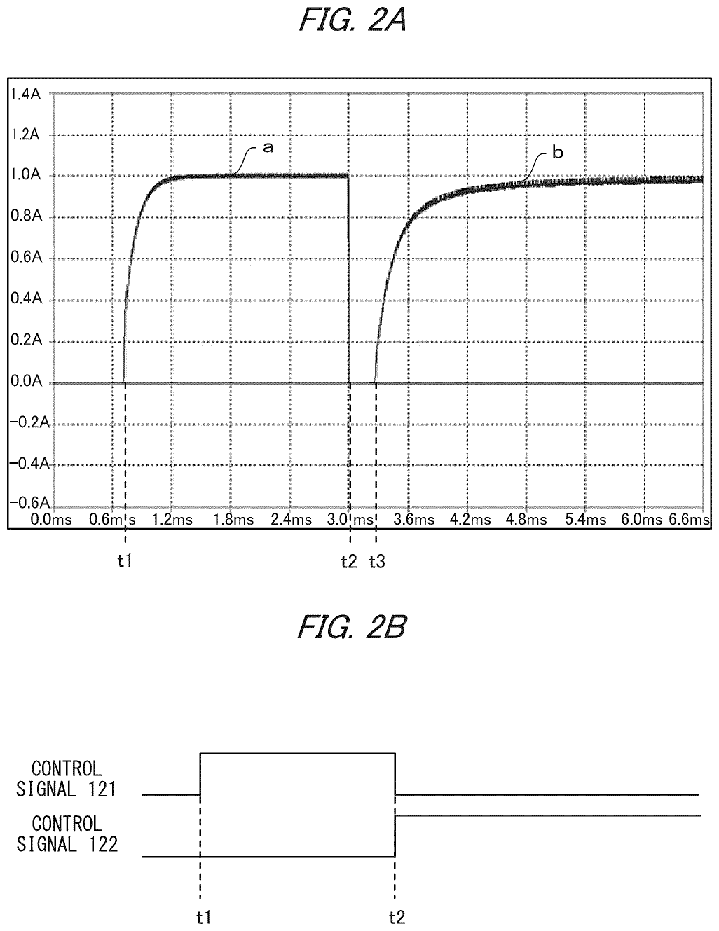

FIG. 2A illustrates, in the lighting control device 4 of the present embodiment illustrated in FIG. 1, a current curve a of a current value at a connection point A that is a connection point between the positive wiring 17 of the step-down DC-DC converter 11 and the high-beam light source 2, and a current curve b of a current value at a connection point B that is a connection point between the positive wiring 17 of the step-down DC-DC converter 11 and the low-beam light source 3. The horizontal axis is a time axis, and the vertical axis indicates a current value. FIG. 2B is a waveform diagram illustrating a control signal 121 that is input by the control circuit 12 to the control terminal of the transistor 13, and a control signal 122 that is input by the control circuit 12 to the control terminal of the transistor 14.

In FIG. 2B, when the control signal 121 output by the control circuit 12 is changed from LOW to HIGH at a time point t1, the transistor 13 is switched to the conductive state (the ON state). As a result of switching the transistor 13 to the conductive state (the ON state) at the time point t1, the current value at the connection point A increases rapidly, and reaches a constant current value that is a rated current value of the light emitting elements 21, 22. After reaching the rated current value, this current value is maintained. Supply of the driving current with this rated current value turns on the high-beam light source 2. During this time, the control signal 122 output by the control circuit 12 is maintained in the LOW state. Thus, the transistor 14 is in the non-conductive state (the OFF state), and the current value at the connection point B is 0.

Next, when changing the function from the high beam to the low beam, the control signal 121 of the control circuit 12 is changed from HIGH to LOW at a time point t2, thereby switching the transistor 13 to the non-conductive state (the OFF state). As a result of switching the transistor 13 to the non-conductive state, the current value at the connection point A decreases rapidly from the rated current value to be 0. This turns off the high-beam light source 2.

The control signal 122 of the control circuit 12 is changed from LOW to HIGH at the time point t2, thereby switching the transistor 14 to the conductive state (the ON state). As described above, the forward voltage of the high-beam light source 2 connected to the connection point A is 2Vf, whereas the forward voltage of the low-beam light source 3 connected to the connection point B is Vf. The low-beam light source 3 has a smaller load than the high-beam light source 2.

Thus, switching the transistor 13 to the non-conductive state (the OFF state) and switching the transistor 14 to the conductive state (the ON state) reduce the load. Such reduction of the load results in discharge of the electric charge accumulated in the capacitor 15.

Due to discharge from the capacitor 15, in addition to the driving voltage applied by the step-down DC-DC converter 11, a voltage discharged by the capacitor 15 is momentarily applied to the light emitting element 31 of the low-beam light source 3. Thus, a current flowing through the connection point B generates, at rising thereof, a surge current due to discharge from the capacitor 15.

In the present embodiment, damage to the light emitting element 31 is prevented by providing the bypass circuit 5 that forms the bypass path for bypass of a current flowing through the light emitting element 31 and includes the transistor 51 and the capacitor 52, and feeding this surge current to the bypass path.

The control signal 122 is input to the base of the transistor 51 via the capacitor 52. When an input voltage is increased at the time point t2 by a signal for rising from LOW to HIGH, a charging current flows to the capacitor 52 until charging thereto is completed. This current flows for an extremely short period of time immediately after rising of the control signal 122 to turn on the transistor 51. As a result of turning on the transistor 51, the bypass path is formed between the positive wiring 17 and the GND wiring 18. This causes the driving current to flow to the bypass path. Thus, even though the transistor 14 is switched to the conductive state, the driving current does not flow to the light emitting element 31 of the light source 3.

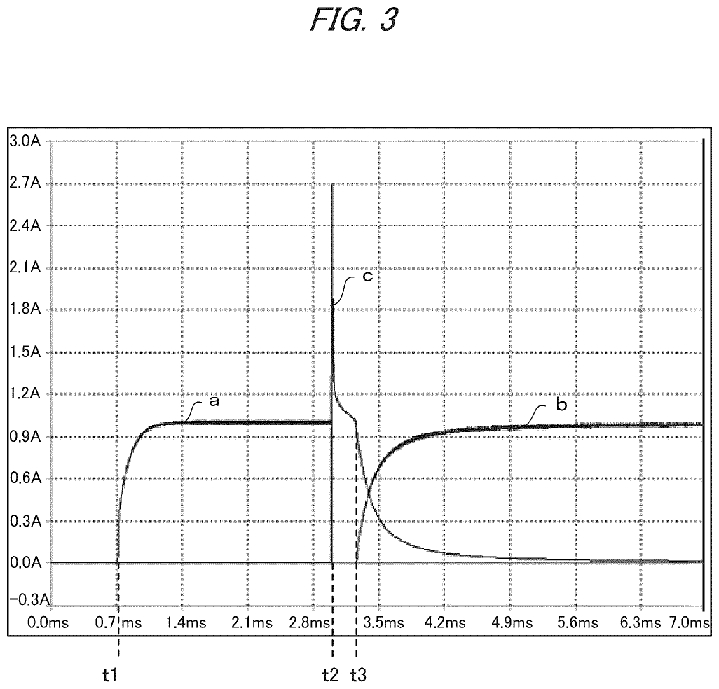

FIG. 3 illustrates a waveform diagram in which a current curve c of a value of a current flowing to the bypass path formed by turning on the transistor 51 is added to the current curve a of the current value at the connection point A and the current curve b of the current value at the connection point B in FIG. 2A. As indicated by the current curve c, when the bypass path is formed at the time point t2 by turning on the transistor 51, the surge current due to discharge from the capacitor 15 flows to the bypass path, and the surge current thus does not flow to the light emitting element 31. This can prevent damage to the light emitting element 31.

The charging current to the capacitor 52 that has started charging at rising of the control signal 122 gradually decreases with time, and the transistor 51 is turned off. A current starts to flow with a delay from the time point t2 to the light emitting element 31 of which the surge current is momentarily bypassed by the bypass path, and as indicated by the current curve b, the current value increases rapidly at a time point t3 to reach the rated current value. This turns on the light emitting element 31, and switches the function from the high beam to the low beam. Since the transistor 51 is automatically turned off by charging to the capacitor 52, the circuit configuration can be simplified. In addition, since the time of turn off can be adjusted in accordance with the capacity of the capacitor 52, adjustment can be easily performed.

As described above, the bypass circuit that forms the bypass path when lighting of the multiple light sources is controlled by the common lighting control device can prevent an excessive current from flowing to the light sources due to load fluctuation and resulting in damage to the light sources.

### Embodiment 2

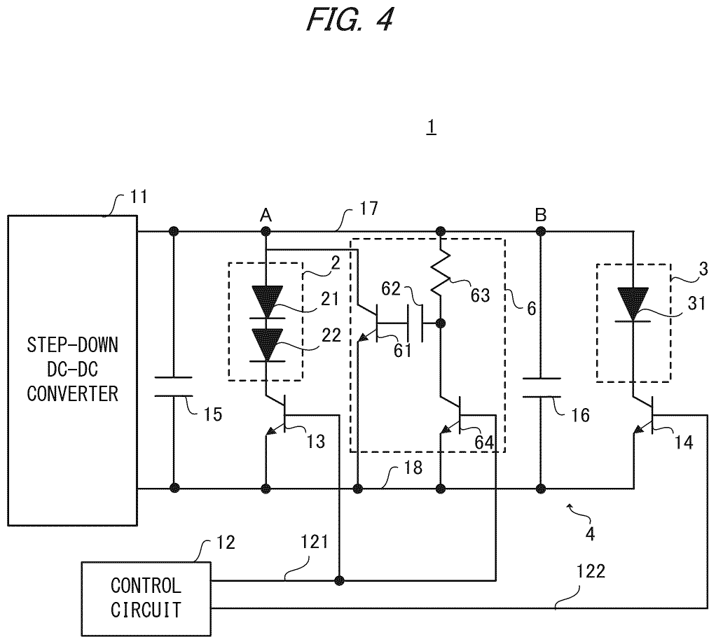

Next, Embodiment 2 is illustrated in FIG. 4. Although the control signal 122 for control of the conduction state to the low-beam light source 3 is used in control of the bypass circuit in Embodiment 1, the control signal 121 for control of the conduction state to the high-beam light source 2 is used in control of a bypass circuit in Embodiment 2.

The components of Embodiment 2 other than the bypass circuit are the same as those of Embodiment 1. Thus, the same reference signs are assigned to the same components as in Embodiment 1, and description thereof is omitted.

A bypass circuit 6 includes transistors 61, 64, a capacitor 62, and a resistor 63. The transistor 61 (the third switching element) is connected between the positive wiring 17 and the GND wiring 18, and forms the bypass path when the transistor 61 is switched to the conductive state. A control terminal of the transistor 61 is connected to one terminal of the capacitor 62. The resistor 63 and the transistor 64 (a fourth switching element) are connected in series between the positive wiring 17 and the GND wiring 18, and a connection point between the resistor 63 and the transistor 64 is connected to the other terminal of the capacitor 62. A base of the transistor 64, that is, a control terminal of the transistor 64 is connected to the control circuit 12, and the control signal 121 for control of the conduction state of the high-beam light source 2 is input to this base.

Next, operation of the bypass circuit 6 when switching the function from the high beam to the low beam is described. While the high-beam light source 2 is turned on, the control signal 121 is HIGH. When the function is switched from the high beam to the low beam, the control signal 121 is changed from HIGH to LOW. As a result of changing the control signal 121 to LOW, the transistor 13 is switched to the non-conductive state, and the light emitting elements 21, 22 of the high-beam light source 2 are turned off. At the same time, the control signal 122 is changed from LOW to HIGH. As a result of changing the control signal 122 to HIGH, the transistor 14 is switched to the conductive state.

As a result of changing the control signal 121 input to the base of the transistor 64 of the bypass circuit 6 to LOW, the transistor 64 is switched from the conductive state to the non-conductive state. While the transistor 64 is in the conductive state, the capacitor 62 is grounded. Switching the transistor 64 from the conductive state to the non-conductive state causes the capacitor 62 to start charging. After starting charging, a charging current flows to the capacitor 62 until charging thereto is completed. This current flows for an extremely short period of time immediately after falling of the control signal 121 to turn on the transistor 61. As a result of turning on the transistor 61, the bypass path is formed between the positive wiring 17 and the GND wiring 18. A surge current due to discharge from the capacitor 15 thus flows to the bypass path. Thus, even though the transistor 14 is switched to the conductive state, the driving current does not flow to the light emitting element 31 of the light source 3.

The charging current to the capacitor 62 that has started charging at falling of the control signal 121 gradually decreases with time, and the transistor 61 is turned off. After the surge current is momentarily bypassed by the bypass path, a current starts to flow to the light emitting element 31, and the current value increases rapidly to reach the rated current value. This turns on the light emitting element 31, and switches the function from the high beam to the low beam.

As with Embodiment 1, the present embodiment can prevent damage to the light sources due to the surge current generated by switching the light sources with different loads.

### Embodiment 3

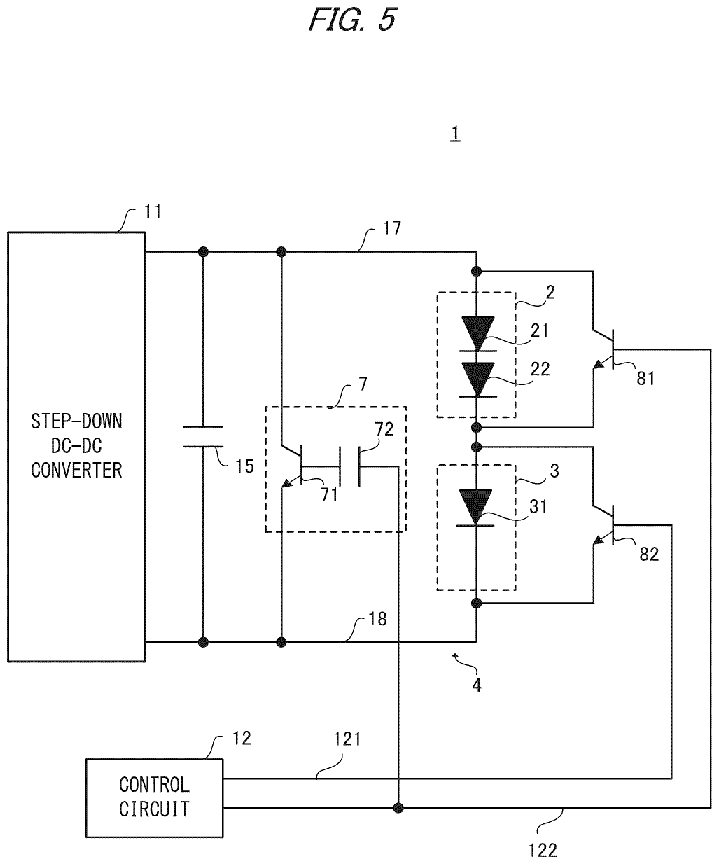

Next, Embodiment 3 is illustrated in FIG. 5. Although the high-beam light source 2 and the low-beam light source 3 are connected in parallel in Embodiments 1 and 2, a case is described in Embodiment 3 in which the high-beam light source 2 and the low-beam light source 3 are connected in series.

In Embodiment 3, the light emitting elements 21, 22 of the high-beam light source 2 and the light emitting element 31 of the low-beam light source 3 are connected in series between the positive wiring 17 and the GND wiring 18. Between an anode of the light emitting element 21 and a cathode of the light emitting element 22, a transistor 81 (the first switching element) is connected in parallel to the light emitting elements 21, 22. Between an anode and a cathode of the light emitting element 31, a transistor 82 (the second switching element) is connected in parallel to the light emitting element 31.

When the transistor 81 is in the non-conductive state, a driving current flows to the light emitting elements 21, 22. Switching the transistor 81 to the conductive state causes the transistor 81 to form a bypass path for bypass of the light emitting elements 21, 22, and the driving current flows through the bypass path and does not flow to the light emitting elements 21, 22. Similarly, when the transistor 82 is in the non-conductive state, a driving current flows to the light emitting element 31. Switching the transistor 82 to the conductive state causes the transistor 82 to form a bypass path for bypass of the light emitting element 31, and the driving current flows through the bypass path and does not flow to the light emitting element 31.

When the high-beam light source 2 is turned on and the low-beam light source 3 is turned off, the transistor 81 is switched to the non-conductive state to cause the driving current to flow to the light emitting elements 21, 22, and the transistor 82 is switched to the conductive state to cause the driving current not to flow to the light emitting element 31. In contrast, when the high-beam light source 2 is turned off and the low-beam light source 3 is turned on, the transistor 81 is switched to the conductive state to cause the driving current not to flow to the light emitting elements 21, 22, and the transistor 82 is switched to the non-conductive state to cause the driving current to flow to the light emitting element 31.

Thus, when the high-beam light source 2 is turned on and the low-beam light source 3 is turned off, the control signal 121 input to a base of the transistor 82 is changed from HIGH to LOW, and the control signal 122 input to a base of the transistor 81 is changed from LOW to HIGH.

A bypass circuit 7 includes a transistor 71 (the third switching element) and a capacitor 72. The transistor 71 is connected between the positive wiring 17 and the GND wiring 18, and forms the bypass path when the transistor 71 is switched to the conductive state. A base of the transistor 71, that is, a control terminal of the transistor 71 is connected to one terminal of the capacitor 72. The other terminal of the capacitor 72 is connected to the control circuit 12. The control signal 122 input to the base of the transistor 81 is input to the base of the transistor 71 via the capacitor 72.

Next, operation of the bypass circuit 7 when switching the function from the high beam to the low beam is described. While the high-beam light source 2 is turned on, the control signal 121 is HIGH, and the control signal 122 is LOW. When switching the function from the high beam to the low beam, the control signal 122 is changed from LOW to HIGH. As a result of changing the control signal 122 to HIGH, the transistor 81 is switched to the conductive state to form the bypass path, and the light emitting elements 21, 22 of the high-beam light source 2 are turned off. At the same time, the control signal 121 is changed from HIGH to LOW. As a result of changing the control signal 121 to LOW, the transistor 82 is switched to the non-conductive state, and the light emitting element 31 of the low-beam light source 3 is switched to the conductive state.

Changing the control signal 122 input to the capacitor 72 of the bypass circuit 7 to HIGH causes the capacitor 72 to start charging. After starting charging, a charging current flows to the capacitor 72 until charging thereto is completed. This current flows for an extremely short period of time immediately after rising of the control signal 122 to turn on the transistor 71. As a result of turning on the transistor 71, the bypass path is formed between the positive wiring 17 and the GND wiring 18. A surge current due to discharge from the capacitor 15 thus flows to the bypass path. Thus, even though the light emitting element 31 is switched to the conductive state, the driving current does not flow to the light emitting element 31.

The charging current to the capacitor 72 that has started charging at rising of the control signal 122 gradually decreases with time, and the transistor 71 is turned off. After the surge current is momentarily bypassed by the bypass path, a current starts to flow to the light emitting element 31, and the current value increases rapidly to reach the rated current value. This turns on the light emitting element 31, and switches the function from the high beam to the low beam.

In the above embodiment, the control signal 122 for control of the transistor 81 is input to the control terminal of the transistor 71 of the bypass circuit 7. However, a configuration may be provided in which the bypass circuit 7 has the same configuration as the bypass circuit 6 of Embodiment 2 and the control signal 121 for control of the transistor 82 is input to a control terminal of a transistor corresponding to the transistor 64 for control of ground of the capacitor 72.

As with Embodiment 1, the present embodiment can prevent damage to the light sources due to the surge current generated by switching the light sources with different loads.

Although the high beam and the low beam are given as examples of the functions in the above embodiments, the functions and the light sources used for these functions are not limited thereto. For example, the present invention may be applied to a turn signal lamp, a position lamp, a daytime running lamp, or the like. The number of functions and the number of light sources used for these functions may be three or more.

In the above embodiments, an example of selective lighting control, such as turning on one of the high beam and the low beam and turning off the other, is described. The present invention may be also applied to, for example, a case where some of multiple light sources are turned on and the others are turned off, if the load is reduced by changing the light sources that are turned on and off.

Although the vehicle lamp is described in the above embodiments, the present disclosure is not limited thereto and may be used as an illumination device to other applications, such as an amusement device.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A lighting control device to control lighting of a first light source and a second light source, the second light source having a smaller load than the first light source, the lighting control device comprising:
a voltage supply circuit to supply a driving voltage to each of the first light source and the second light source;
a smooth capacitor to absorb a ripple of the driving voltage supplied by the voltage supply circuit;
a first switching element to control flowing of a current generated by the driving voltage to the first light source;
a second switching element to control flowing of a current generated by the driving voltage to the second light source;
a control circuit to output control signals for control of the first switching element and the second switching element;
a bypass circuit to form a bypass path for bypass of a current flowing to the second light source, wherein
the bypass path is formed by switching the bypass circuit to a conductive state based on a control signal for reduction of the load among the control signals output by the control circuit.

2. The lighting control device according to claim 1, wherein
the bypass circuit includes
a third switching element, and
a capacitor connected to a control terminal of the third switching element, and
the control signals are input to the control terminal of the third switching element via the capacitor.

3. The lighting control device according to claim 2, wherein
lighting of the first light source and the second light source is selectively controlled,
the first light source and the second light source are connected in parallel,
the first switching element is connected in series with the first light source,
the second switching element is connected in series with the second light source, and
the bypass circuit inputs a control signal for control of a conduction state of the second switching element, included in the control signals, to the control terminal of the third switching element via the capacitor.

4. The lighting control device according to claim 2, wherein
lighting of the first light source and the second light source is selectively controlled,
the first light source and the second light source are connected in parallel,
the first switching element is connected in series with the first light source,
the second switching element is connected in series with the second light source, and
the bypass circuit inputs a signal reverse to a control signal for control of a conduction state of the first switching element, included in the control signals, to the control terminal of the third switching element via the capacitor.

5. The lighting control device according to claim 2, wherein
lighting of the first light source and the second light source is selectively controlled,
the first light source and the second light source are connected in series,
the first switching element is connected in parallel to the first light source,
the second switching element is connected in parallel to the second light source, and
the bypass circuit inputs a control signal for control of a conduction state of the first switching element, included in the control signals, to the control terminal of the third switching element via the capacitor.

6. The lighting control device according to claim 2, wherein
lighting of the first light source and the second light source is selectively controlled,
the first light source and the second light source are connected in series,
the first switching element is connected in parallel to the first light source,
the second switching element is connected in parallel to the second light source, and
the bypass circuit inputs a signal reverse to a control signal for control of a conduction state of the second switching element, included in the control signals, to the control terminal of the third switching element via the capacitor.

7. The lighting control device according to claim 4, further comprising:
a fourth switching element to connect the control terminal of the third switching element to a ground potential via the capacitor, wherein
the control signal for control of the conduction state of the first switching element is input to a control terminal of the fourth switching element.

8. The lighting control device according to claim 6, further comprising:
a fourth switching element to connect the control terminal of the third switching element to a ground potential via the capacitor, wherein
the control signal for control of the conduction state of the second switching element is input to a control terminal of the fourth switching element.

9. An illumination device comprising the lighting control device, the first light source, and the second light source according to claim 1.

10. A vehicle lamp configured using the illumination device according to claim 9.
